(19) United States
(12) Patent Application Publication
(10) Pub. No.: US 2014/0006123 A1
(43) Pub. Date: Jan. 2, 2014

(54) Microgift System and Method of Operation

(71) Applicant: Weyenot, Inc., (US)

(72) Inventor: Jon Kepecs, Woodside, CA (US)

(73) Assignee: WEYENOT, INC., Menlo Park, CA (US)

(21) Appl. No.: 13/710,309

(22) Filed: Dec. 10, 2012

Related U.S. Application Data
(60) Provisional application No. 61/568,825, filed on Dec. 9, 2011.

(51) Int. Cl. G06Q 30/06

(52) U.S. Cl. CPC G06Q 30/0601
USPC 705/14.16; 705/26.1; 705/14.49

(57) ABSTRACT

A computer system implements a microgifting service where a gift of a specific item, valid only for a specific amount of time, is provided via the system upon purchase of the gift by a giftor to a giftee. The giftor is notified by the system upon redemption or expiration of the gift, and where the value of the gift is refunded to the giftor should the gift expire.

### CROSS-REFERENCE TO RELATED APPLICATIONS

This patent application claims priority to Provisional Patent Application No. 61/568,825, entitled “Microgift System and Method of Operation,” and filed Dec. 9, 2011.

### BACKGROUND OF THE INVENTION

In today's world of social networking, it is commonplace to offer virtual gifts (e.g., an image of a flower or a cupcake) that can be ‘sent’ to a user, perhaps to celebrate an event or act as a ‘thank you’ notification. Other forms of real gifts are largely limited to forms of gift certificate.

A gift certificate is redeemable essentially forever for any goods or services which a merchant offers. For a gift certificate, the amount of the gift certificate may be more than the amount of the item purchased in which case, the receiver of the gift (the giftee) may have an insignificant amount remaining on the gift card or certificate which they never bother to use—the value is thus effectively lost. Or, the amount of the gift certificate may be less than the amount of the item purchased, in which case the giftee has to pay out additional funds, which is hardly in the spirit of a gift. Additionally, a gift certificate is generally exchangeable for any good or service sold by a merchant, even if the gift certificate is stated to be valid for a specific item. This means that the merchant cannot offer a gift on a specific item, which may be a higher margin item than one sold at a similar price. For example, a pet store may make only 10% margin on a $10 bag of dog food, but may make 60% margin on a $10 pet raincoat. Thus, the pet store might prefer to have $10 gifts issued on pet raincoats instead of pet food. Finally, a gift certificate is generally valid for an extended period of time (5 years or longer in most cases) so the sale of a gift certificate is often uncorrelated in time to the purchase of a gift which complicates efforts to analyze marketing campaigns for effectiveness. Furthermore, another problem with a gift certificate is that the giftor does not know if the gift certificate was actually redeemed (or perhaps sold on a gift certificate exchange, or redeemed by someone else).

The present invention is directed toward real gifts, generally of small value, although not necessarily so limited, and which represent specific items available at specific merchants (a merchant could be a real brick and mortar merchant or a web merchant).

### BRIEF SUMMARY OF THE INVENTION

The present invention provides for a computer method and system for managing a microgift program with gifts available at one or more merchants. The computer method comprises presenting a selection to a giftor of merchants where gifts are available, along with, in some cases, specific gifts available at that merchant and identification of prices (which can represent the true price of an item, a discounted price on the item, or even an increased price on the item, along with a service fee that is due the microgift system provider) for these gifts. Upon gift selection, a giftor designates the mechanism by which the giftee is notified of the gift and gift redemption means, possibly accompanied by a message which may be generated by the system or the giftor. The giftee utilizes the presented redemption mechanism to redeem the gift at the specified merchant, the redemption causing the giftor to be notified of the successful completion of the gift. If the gift is not redeemed within the specified time, the system automatically notifies the giftor and deposit into an account accessible to the giftor the value of the gift (possibly less a fee). In some cases, a gift is only partially redeemed, in which case the unredeemed portion is returned to the giftor. The giftee may elect to designate their gift to be donated to a charity instead of actually redeeming the gift; this constitutes a redemption to the system and the giftor is notified of a successful redemption.

The redemption mechanism is typically a code, such as described in U.S. patent application Ser. No. 13/477,010, or may be a credit/debit card number generated specifically for this purpose; in this case, the credit card number (PAN) serves as the code, and the merchant is remunerated via the credit card mechanism.

A codesheet mechanism validation requires the giftee to provide to the service network a merchant code associated with the desired gift which causes a confirmatory response gift code from the service network. If this response gift code matches the gift code linked to the merchant code which the merchant can view on their codesheet, then the gift is delivered. The service network calculates in advance a set of merchant codes and gift codes and provides this set of code pairs to the merchant.

A third party may elect to recruit a merchant by asking a merchant to participate in the system (a merchant may be able to participate at some level without actively agreeing to participate if the redemption means support redemption without requiring the merchant to interact directly with the system). The third party is presented with a list of merchants who are not yet participating. Upon selection of a non-participating merchant, the third party is given a fixed amount of time to encourage the merchant to actively participate in the system, perhaps by featuring their gifts more prominently than non-participating merchants. If this merchant participates in a registration process with the system, that third party is compensated for having recruited this merchant (even if the merchant happened to register without the intercession of the third party).

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows the general elements of a microgifting system according to an embodiment of the present invention wherein the giftor selects a gift, pays for the gift, and causes delivery of the gift notification to the customer.

FIG. 2A shows the path wherein the customer obtains the redemption means (e.g. a code) in the gift notification; FIG. 2B shows the path wherein the customer must further interact with the system to obtain the redemption means and possibly additional communication about the gift. In the case of a codesheet, the customer will eventually provide a merchant code supplied by the merchant. In other cases, the customer may be asked to prove their identity in order to obtain a code. Possession of a special URL which contains a code can constitute identity proof.

FIG. 3A shows the path wherein the customer presents the redemption means to the merchant and the merchant validates the redemption means via direct communication with the system. FIG. 3B shows the path wherein the customer presents a code consisting of a credit/debit number to the merchant who enters this number into their existing credit/debit processing system which in turn notifies the system about the redemption of the gift. FIG. 3C shows the path where the customer enters a merchant code obtained from the merchant into the service network system, and receives a gift code that must match the gift code linked to the merchant code in the merchant's possession. If the gift code matches a gift bound to the giftee's account, the gift is assumed to be redeemed without further merchant interaction. The merchant code provided by the merchant may be specific to a specific gift.

FIG. 4 illustrates a merchant selection process where a third party selects an available merchant to enroll, the merchant enrollment within a specified time period causing remuneration of the third party.

### DETAILED DESCRIPTION OF THE INVENTION

Unlike a gift certificate, which is redeemable essentially forever for any goods or services which a merchant offers, a microgift, i.e., a gift under the described system of the present invention, is valid for a specific item, a good or service. This generally means that for the microgift, the price paid by the giver of the gift (the giftor) includes the item, any applicable sales tax, and gratuity if applicable. From the merchant's standpoint, a microgift can be set to a specific item, which allows the merchant to obtain a higher margin or some other benefit. The microgift is valid for specified time so the microgift is correlated in time to the purchase of the item to allow easy analysis marketing campaigns. Furthermore, the giftor is notified when the microgift is actually redeemed. The value of a microgift, if not redeemed quickly by the giftee, reverts to the giftor to use to purchase a different microgift, possibly for a different giftee. Some of the key novel features of a microgift system of the present invention includes the following features:
i) Valid for specific gift;
ii) Valid for finite time;
iii) Giftor is notified automatically if giftee redeems or doesn't redeem the gift;
iv) No need for giftee to pay additional funds for a gift or have small useless amounts remaining;
v) If desired, only the giftee can redeem the gift (it cannot be “re-gifted”);
vi) Value of gift accrues back to giftor if gift is unredeemed.

### Basic Elements and Operation of the Microgift System

It should be noted that “merchant” and “merchants” refer to the establishment(s), the human actor(s) controlling the establishment, or the establishment computer device(s), as is readily evident from the context in which the terms are used. Likewise, “customer”, “giftor”, “giftee” and “customers” refer to human actor(s) or their computing devices, depending upon the context of usage. microgift system refers to the collection of computers and programs accessed by giftees, giftors and merchants that implement the gifting and redemption capability.

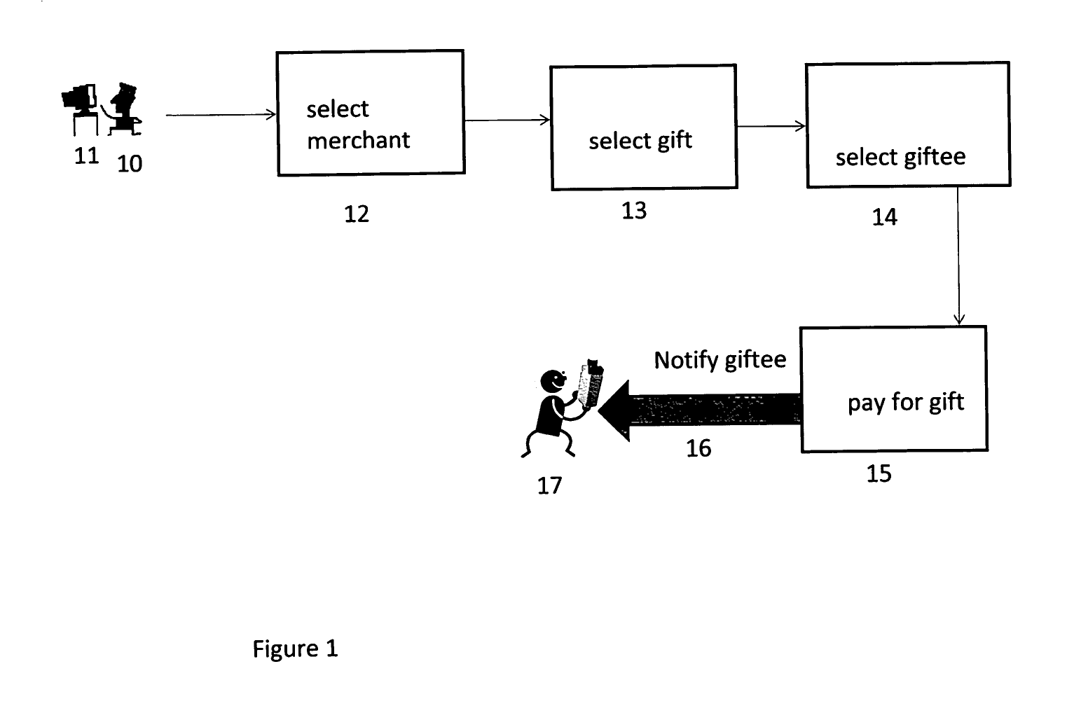

FIG. 1 illustrates the general elements of microgift system according to one embodiment of the present invention. Giftor 10 interacts with a web browser or smart phone or similar device 11 to interact with the components of the service network. The first component 12 allows the customer to select a merchant where the gift is to be acquired by the giftee. The second component 13 optionally allows the customer to select a specific gift at said merchant. The third component 14 allows an individual giftee to be designated, typically by email address, phone number (for texting or calling), or social media identifier. Next, the giftor pays for the gift by interacting with a payment service 15, such as a credit card processing network. Finally, the notification of the gift 16 is delivered to giftee 17. The order of steps 12, 13 and 14 is interchangeable.

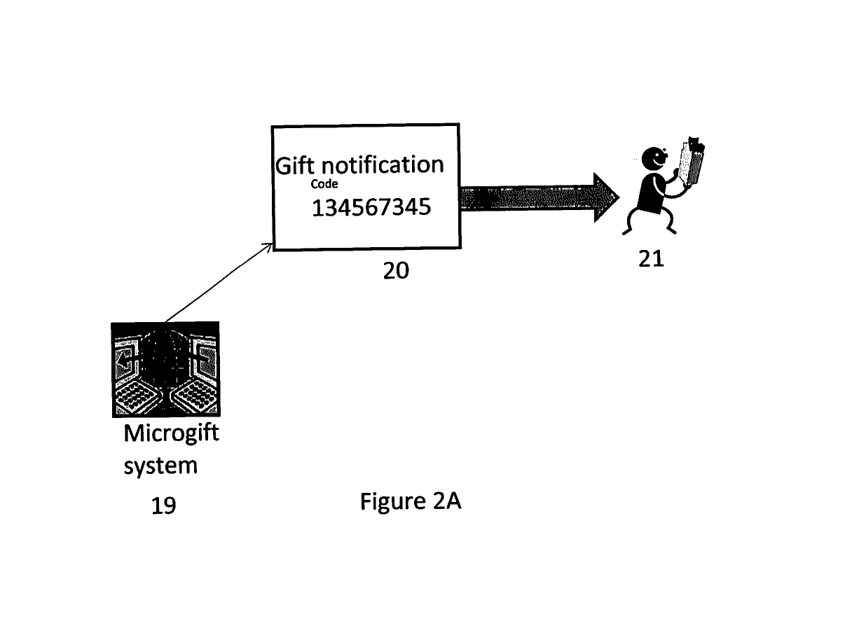

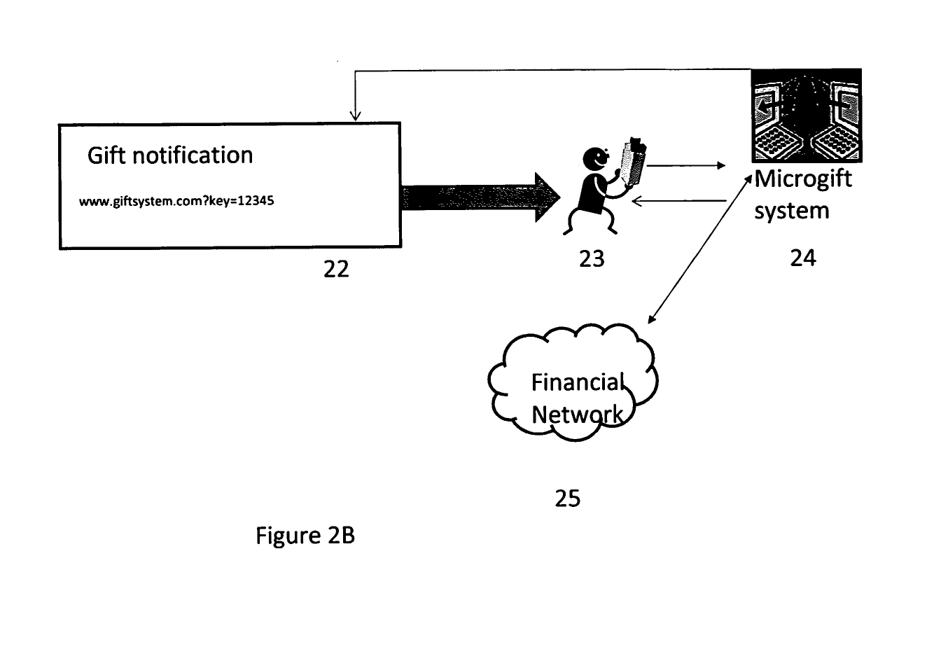

FIG. 2A illustrates a gift notification which contains the redemption means 20 (such as a code) is provided directly to the giftee 21 by microgift system 19. FIG. 2B illustrates the notification 22 directing the giftee 23 to perform an action (such as visit a web site to view a code or to enter a codesheet key) in order to complete a redemption. This action involves a communication with the microgift system 24 to obtain a redemption code. In one embodiment, the giftee is supplied with a special code in a URL which, when passed to the microgift system, is linked to a redemption code that the giftee may supply to the merchant. In another embodiment, the giftee supplies credentials to identify themselves to the microgift system in order to obtain a code. In still another embodiment, the giftee calls an 800-number which identifies the calling phone number of the giftee which in turn is linked to the account of the giftee and serves to provide authentication of the giftee such that the giftee may receive appropriate codes, possibly in response to the entry of a merchant code. By way of example, a debit/credit card PAN might serve as the redemption code in either method 2A or 2B. Here, if a PAN is employed, it is obtained by microgift system 24 via financial network 25.

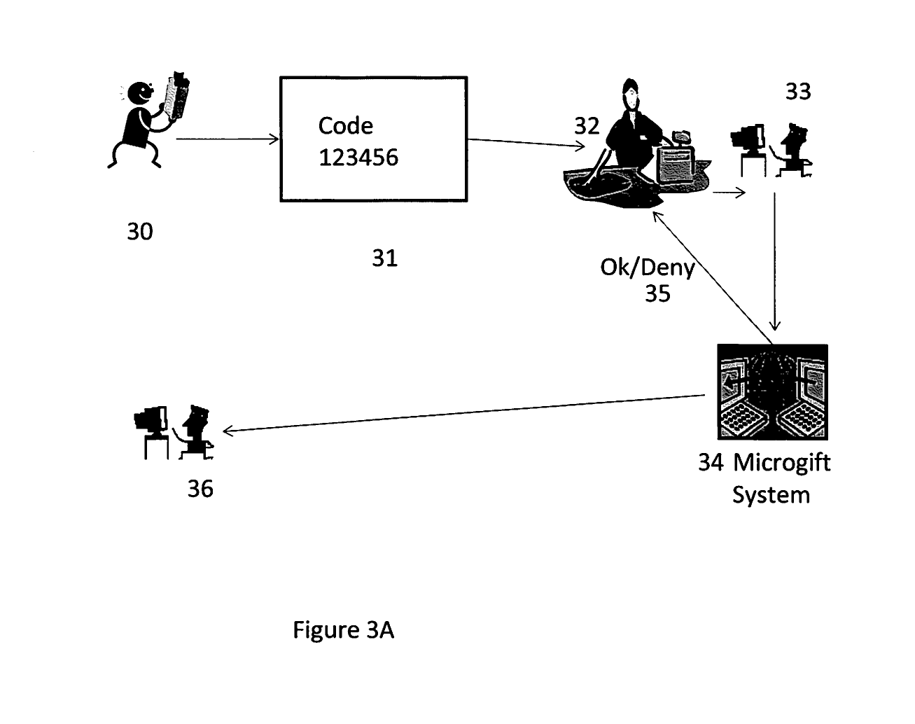

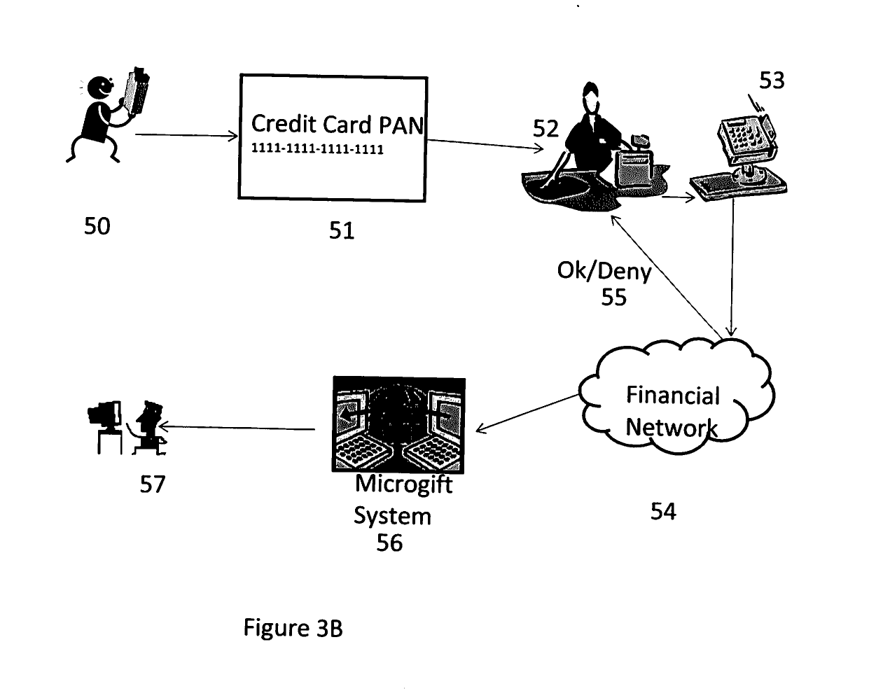

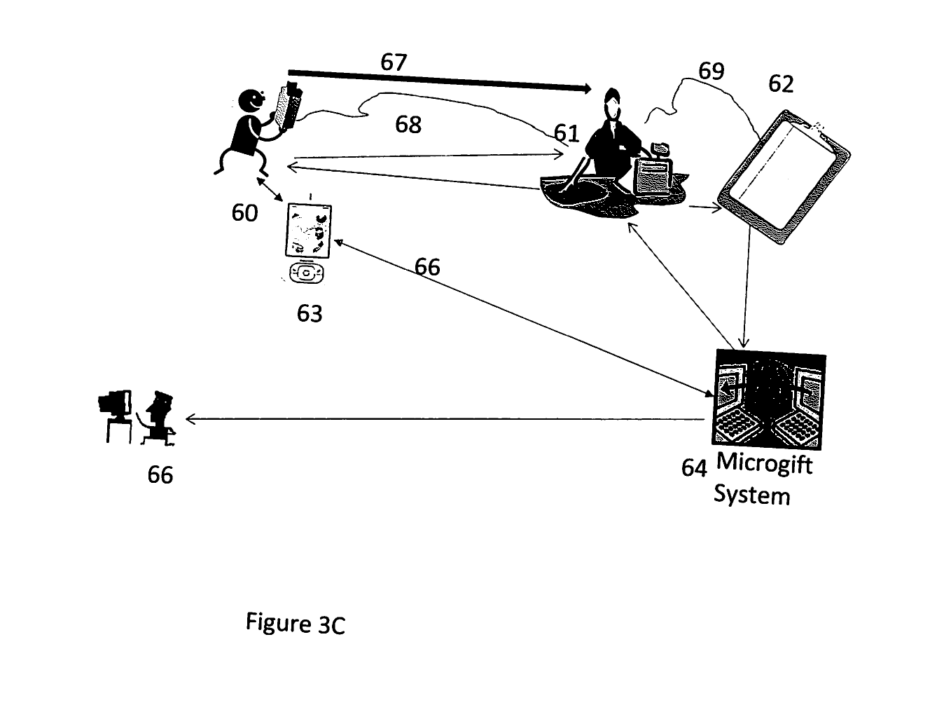

FIG. 3A illustrates a gift redemption where giftee customer 30 presents code 31 obtained previously to merchant 32 who in turn enters this code into a device 33 such as a web browser or smart phone connected via a network such as the Internet to the microgift system 34. The microgift system 34 looks up the code and returns a status 35 to the merchant indicating if the code is valid for the gift in question. To ensure that the code in question is relevant to the merchant, the merchant may be required to identify themselves to the microgift system 34 so that the code in question can be confirmed as being relevant to merchant 32. The fact of redemption is then communicated by the microgift system 34 to the giftor 36. Should the gift not be redeemed prior to the expiration of the gift that is managed by microgift system 34, the validity of the code is withdrawn and the value of the gift is returned to an account owned by giftor 36 that can be used to purchase other gifts. The amount due the merchant is calculated by microgift system 64 and the merchant is remunerated for the price of the gift, typically by check or wire transfer.

FIG. 3B illustrates a gift redemption in which the redemption code 51 provided to the giftee customer 50 is a credit/debit card number, sometimes called a PAN (Primary Account Number) and any associated information such as an expiration date and 3 or 4 digit card verification code (CVC). The giftee customer provides the code(s) to merchant 52 who enters the codes in a credit card processing device 53, such as a point of sale (POS) terminal, that in turn communicates with a financial network 54. The value of the card may be less than, equal to, or greater than the value of the gift. The transaction details are reported by the financial network to the microgift system 56. The giftor 57 is then notified of a successful redemption, and in the case where the some of the value of the gift was unused, the unused portion (possibly less a processing fee) is returned to the account of the giftor maintained on microgift system 56. Should the gift not be redeemed prior to the expiration of the gift managed by microgift system 56, the validity of the code 51 is expired by financial system 54, and the microgift system 56, upon verification of the expiration of the code, reports an unredeemed gift to the giftor 57 and rebates the value of the gift to the account of the giftor 57. The merchant is remunerated via the credit card mechanism implemented by financial network 54.

FIG. 3C illustrates a codesheet redemption where giftee 60 describes the gift they wish to redeem to merchant 61. Merchant 61 looks up the merchant code on a precalculated sheet of codes 62 and provides it to giftee 60 (path 68). Giftee 60 uses a phone or smart phone or other device that is capable of communicating remotely with microgift system 64 which in turn provides a gift code via path 66 to giftee 60. Path 66 is typically the same network or phone connection utilized by device 63. Giftee 60 then provides the gift code to the merchant 61 via path 67 (typically a verbal or written communication). If the merchant code has matched a valid gift, the microgift system 64 records a redemption and reports it to giftor 66. The merchant 61 then compares this merchant code to the precalculated merchant code on codesheet 62 (path 69), and if there is a match, the gift is provided to giftee 60. Again, if no code is provided for the gift in question prior to its expiration, microgift system 64 rebates the value of the gift to the account maintained by microgift system 64 on behalf of giftor 66. The amount due the merchant is calculated by microgift system 64 and the merchant is remunerated for the price of the gift, typically by check or wire transfer.

In all cases, giftee may elect to not redeem gift at a merchant and instead designate the amount of the gift be applied to a charity prior to the expiration of the gift; the giftor is notified that the giftee made a redemption as in the previous cases. This only requires that the giftee indicate to the microgift system his or her desire to donate the gift to charity, in which case the microgift system will invalidate the redemption means, record the amount due the selected charity, and notify the giftor of a redemption.

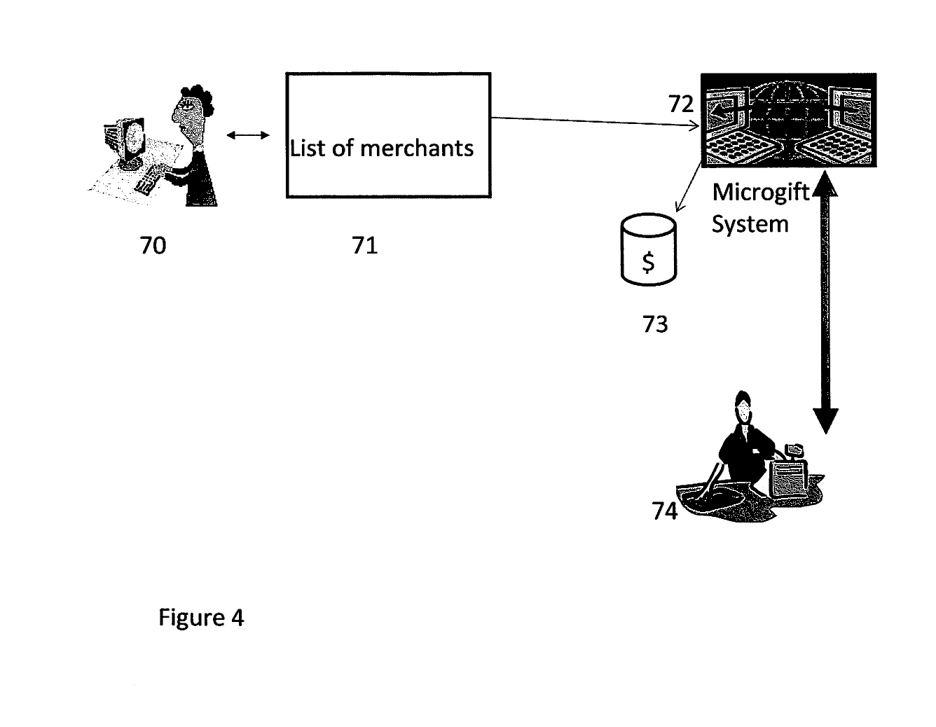

FIG. 4 illustrates the mechanism where a third party 70 selects a merchant 74 to recruit from a list 71 provided by microgift system 72. The selection is typically done over the Internet via a web browser or smart phone. Upon selection, this merchant is unavailable to other third parties for recruitment for a period of time. If the merchant 74 enrolls in the system by communicating with microgift system 72 prior to the period of time expiring, a credit is placed in an account 73 maintained by microgift system 72 and which may be used by third party 70 for gift purchases. Alternatively, third party 70 may receive direct remuneration for a successful enrollment. It is not necessary in most cases for merchant 74 to identify third party 70, so that if merchant 74 enrolled without encouragement from third party 70, third party 70 simply got lucky.

### Further Description of the Features and Operations of the Microgift System

In addition to the basic features of a microgift, a giftor must select the friend to give a gift to. This is accomplished by asking the giftor to identify a friend by some means, such as the friend's identity on a social network such as Facebook or Google+, email address, phone number, physical address, or other means such as a photograph, voiceprint sample, or a code that the giftor can share directly with the giftee. A merchant who knows what a customer looks like could select that customer on a social network if the customer has registered on the merchant's social network site and associated a picture of themselves on the social network, or even if the merchant can take a picture of the customer which can be matched to the customer's social network identity by available programs.

The giftor may have specific information about the location of the giftee that would enable selecting an appropriate gift (for example, knowing that the giftee was on vacation might allow the giftor to select a gift at the vacation location of the giftee). Alternatively, the giftor may rely on knowledge about the giftee's location known to the social network, or made available to giftors by giftees on a microgift web site operating in accordance with the present invention. The microgift system may in some cases be able to determine the location of the giftee in order to appropriately offer a giftor appropriate gifts to select from, or to automatically select a gift (e.g., a flower at nearest flower store to giftee's home or business address). Sometimes this location is known statically (e.g., from information provided by the giftee to either the social networking site or the Microgift site); sometimes it is known dynamically from location-sensing devices carried by the giftee (such as GPS-enabled mobile telephones, smart phones, laptop computers, electronic tablets and the like) and relayed to the giftor, possibly via the microgift system or possibly via other systems.

The microgift must be validated securely. Expanding upon the methods discussed in Provisional Patent Application No. 61/487,886 (“Customer Loyalty System and Method of Operation”), now U.S. patent application Ser. No. 13/477,010, filed May 21, 2012, a novel validation mechanism is presented which allows a merchant to securely validate that a giftee is entitled to the gift and that the gift cannot be redeemed more than one time. Further, the validation means can ascertain that the giftee is indeed the intended recipient and has not re-gifted the gift (this feature does not need to be enforced to retain the properties of a microgift). The validation means should allow for multiple identical gifts (such as a dozen roses, each given by a different giftor) to be redeemed efficiently. Also, when the gift is redeemed by a giftor, the system should automatically notify the giftor of the redemption (perhaps with a message initialized by the giftee) and if the giftee does not redeem the gift within the specified timeframe, the gift value automatically accrues back to the giftor's account.

An additional feature of the microgift system is that a giftor can establish a contributory account wherein multiple gifts can be given to a given giftor, perhaps as a surprise. In this case, the giftor can establish an account without the knowledge of the giftee, and notify other potential giftors about the intent to issue a gift. The other giftors could all contribute towards a single gift, or each could give a gift to be delivered en masse to the giftee (for example, by asking each giftor to give a single rose, and the total set of roses given at a specific merchant can be redeemed in one visit by the giftee, along with notification of the identity of the giftors.)

It is commercially important for merchants to be able to be recruited efficiently to use the present system. To accomplish this, one novel feature of the system is to allow third parties to ‘claim’ a merchant for a short period of time. If the ‘claimed’ merchant registers to be part of the system, the third party is rewarded, perhaps with free gifts that are redeemable at the merchant in question. If the claimed merchant does not register with the microgift system to offer gifts, the third party is prevented from claiming this merchant again (perhaps for a finite period of time) and another third party is allowed to claim the merchant. It is expected that a third party who claims a merchant will attempt to communicate directly with the merchant to explain the benefits of the present system and encourage the merchant to register.

The present system allows for viral distribution of gifts. For example, a given customer may be issued a fixed number of gifts to distribute, and each redeemer of a gift also receives a number of gifts that can be distributed to their friends. The system can ensure that a giftee cannot redeem multiple gifts. In this way, a merchant might attract a large number of visitors to their store, especially if the gifts being distributed are free or heavily discounted.

The present system also allows for manufacturers to distribute gifts. Manufacturers spend heavily on free samples, and the present system allows for a novel mechanism for manufacturers to distribute these or other tokens of appreciation (which could simply be gifts unrelated to the manufacturer's product) in order to reward a behavior (such as registering with the manufacturer or ‘liking’ a manufacturer's social page) or to encourage product trial. In the present system, the manufacturer would be able to target a gift to a user of the system based on past gift redemption history or attributes supplied by the customer. The customer would be offered a relevant gift at a merchant in close physical proximity to the customer, and the manufacturer benefits in several ways from using the present system:

i) A specific merchant can be designated from a specific fund allocated to that merchant (“trade funds”). The manufacturer can allocate these trade funds in a way that is automatic, and where unredeemed gifts are automatically rebated to the manufacturer. This can assist the manufacturer in relations with specific merchants (e.g., to encourage specific merchants to carry or feature prominently a particular product in exchange for offering the gift in question to customers of a specific merchant).

ii) Unlike coupons or rebates, the gift is securely redeemed using the present system's validation means with no coupon clearing overhead on the part of the merchant and no possibility of consumer fraud.

iii) Unlike coupons, fund accounting (to manufacturer, customer and merchant) can happen in nearly real time.

iv) As the giftee is securely identified with the validation means defined by the system, a gift can be securely given at most once to a given giftee.

v) The viral marketing techniques previously discussed can be applied to securely distribute a large number of gifts quickly.

The System

The microgift platform consists of a network of computers providing the microgift service (the service network). Some of the service network computers provide a web interface wherein giftors may identify a giftee and a gift, pay for the gift via a variety of means, and cause the giftee to receive notification of the available gift via a variety of means. Notification means may include posting on the wall of a social network, SMS text message, email message, automated phone call, or other mechanisms. The web interface may provide a location-dependent function for identifying merchants offering a gift near the location of the giftee, whereby a giftor can identify the geographical vicinity of a giftee; rely on information about location supplied by the giftee explicitly (e.g., when the giftee enrolls in the microgift system); rely on location derived from inferences based on an account a giftee might have on a social networking site; rely on location derived from giftee's current location as determined by phone GPS, rely on location derived from giftee's ISP source Internet address, or rely on information known by the giftor (e.g., that the giftee is currently travelling to Paris and would appreciate a gift at a specific store there).

The giftee must either register with the microgift service, or be provided with a unique code or identifier by the giftor that can be used to securely prove the ownership of the gift at gift validation time. Typically, the giftee will register a phone number such that the giftee's mobile phone, when calling an 800-number, can, via caller ID or ANI, determine the specific giftee. Alternatively, the giftee will be provided a code that the microgift system provided to the giftor to uniquely identify the gift. This code might be directly conveyed to the giftor who in turn can convey it to the giftee. In another embodiment, the giftee is provided a unique code or codes by the microgift system (possibly via emailed encrypted URL) that must be subsequently validated by the microgift system. The codes can be generated by the service network, or acquired from a third party such as a credit/debit card provider.

When the giftee is notified of the gift availability, the microgift tracking system sets a timeout on the gift such that the gift, if not redeemed, has its value properly accrue back to the giftor when the validity period expires. If the gift is redeemed prior to the timeout, a (user configurable) message can be sent from the giftee to the giftor automatically, thanking the giftor for the gift. If the gift is not redeemed, the giftor's account is replenished with the value of the gift and the giftor is notified of the non-redemption event.

A giftor need not know the giftee. For example, a giftor might capture the picture of the giftee and have that picture identified by a service that matches pictures to accounts on a social network. Then, the giftor could offer a gift to that person, perhaps in order to meet an interesting-looking person with a friendly gift offering as an introduction.

Gifts may be paid for in a variety of ways: they may be paid for in actual currency (e.g., via credit card transaction), virtual currency (e.g., via virtual currency that can be converted into cash equivalents), or free (e.g., the merchant or a third party effectively pays for the gift). The microgift system managers might give free gifts to ‘seed’ the system with participants. In some cases, the microgift manager receives a convenience fee, paid for by the giftor, which is deducted at the time of either payment for the gift or redemption of the gift, depending upon system configuration.

Gift payments are tracked by type as well as amount. For example, a free gift valid at merchant M, if unredeemed, accrues back to the giftor as a free gift valid at merchant M, not a cash equivalent. Among other things, this prevents a giftor who is given a free gift to issue to a giftee at merchant M receiving funds from an unredeemed gift at M and purchasing a gift at merchant P, effectively using M′s money to subsidize P. Additionally, if a customer has in his account access to several forms of payment, the available resources are matched by the microgift system according to pre-set business rules. As an example, a customer with a generic free gift, a free gift valid at a specific merchant, and a cash account (from unredeemed gifts paid for in cash equivalents) might have a new gift paid for first using any merchant-specific free gifts, then, the next gift paid for by a combination of cash from their cash account and real cash equivalents if the cash account was not sufficient to pay for the entire gift.

Note that notifications of giftor or giftee of events may take place via social networks, email, phone messages, text messages, notifications on a smart phone, or other means. However, the microgift system itself does not rely up any gift-specific mechanisms in a social network or other provider—the social network is used for notification, and, in some cases, to facilitate selection of friends and to facilitate login interactions, said facilitations being standard applications of social networks used by a variety of different external systems.

The microgift system can enforce limits and budgets—for example, on the maximum number of gifts redeemable at any one time at a given merchant. Gifts can also be scheduled to become available on specific dates and to stop being offered on specific dates, such that pending issued, yet unredeemed gifts are still allowed to be redeemed while new offerings of the suspended or stopped gift are prohibited.

Validation Means

The microgift system provides, in addition to more traditional methods, a novel means of validating gifts that does not require merchant IT (Information Technology) modifications and relies entirely on hardware (mobile devices) supplied by the giftee. The validation method described below allows for security (a customer cannot, for example, copy an image of something that states the customer is entitled to a gift and display the image to the merchant) while still retaining the valuable property that the customer's own phone is employed. In essence, the present method provides a way for the merchant to trust the customer's own phone. This is especially valuable for many merchants who do not allow employees to use their own phones during business operations.

In the present method, the merchant prints out (or has printed for them) code sheets consisting of unique merchant codes, each of which is associated with one or more gift codes(keys) and each of which is bound to a specific merchant. A gift key code need not be unique, but should be of sufficient length to be difficult to guess. Each customer has an account in the microgift system, where said account has an associated unique account number. Further associated with an account can be one or more email addresses, snail mail address, phone numbers, and other attributes of the giftee. In one embodiment, the giftee registers their mobile phone number as an attribute of their account. Upon calling an 800-number, the caller's phone number is provided automatically to the microgift provider. In turn, the microgift provider system can look up which account is associated with the phone number. The caller then asks the merchant for one of the unique merchant codes. The merchant provides this code from a pre-printed sheet to the giftee, who in turn enters this code on their phone. The code is looked up in a database maintained on the microgift provider system to see what merchant is bound to the code, and then to validate that the customer bound to said phone number has available gifts at the merchant. At this point, the customer selects the gift they wish to redeem, and the microgift provider phone system provides a gift key to the customer. This key is chosen to match the corresponding key for the gift in question associated with said merchant code (a given merchant code may have multiple gift keys associated with it). The customer communicates the key to the merchant, and if the key matches what is printed on the sheet, the merchant provides the associated gift to the customer. Note that the binding to a specific set of gift keys tied to a merchant code to a specific giftee's gifts is done dynamically, and that when a key is spoken by the microgift provider's phone system, the gift is assumed to be redeemed.

Note that the code sheets a merchant prints need not (and should not) be copied by the merchant—each code sheet is unique. Furthermore, it is not necessary to synchronize amongst different clerks which code sheet is being used as any code on any sheet that has not been previously used can be employed to validate a gift. It is only necessary for any clerk to avoid re-issuing a merchant code on their own sheet (typically, the clerk marks codes as used with a pen or pencil).

This validation mechanism can also be applied to smart phones, such as the iPhone and Android devices—a giftee might pre-select the gift they are interested in, or have the set of available gifts chosen by geographical proximity to a merchant using a phone's GPS system. Then, the customer may follow the protocol of entering a merchant code and validating a key as above, but typing in the code instead of keying it in on a phone, and seeing the gift code instead of hearing it. Alternatively, as in the dumb phone method, the set of gifts available at the merchant associated with the merchant code in provided to the customer can be ascertained when the customer is in the store, but this does not take advantage of the smart phone location capabilities to narrow the field of likely merchants automatically or allow a more complex interaction between the customer and microgift system to select desired gifts in advance. The merchant code is, however, always correlated to the merchant offering gifts actually due the giftee. The means by which the giftee identifies themselves to the microgift system when using a smart phone may not involve use of phone number, but instead may entail using other validation methods such as those provided by social networks or by normal {name, password} validation mechanisms.

Additional information might be conveyed to the microgift system by the merchant which is not known in advance of the gift redemption—for example, the tax status of a gift (gifts consumed in a store might be taxed differently than gifts consumed outside the store), the name of the clerk, or other information, by including a prefix or suffix to the merchant code. For example, a 10 digit merchant code might be prefixed with ‘1’ to mean ‘taxable’ and ‘0’ to mean ‘non-taxable’. This information can be used to generate more accurate accounting to the merchant, and to be certain that the gift paid for by the giftee properly includes all relevant sales taxes. Another use might be to include pre-assigned prefixes to identify specific clerks such that the giftee can record commentary about the clerk who served them anonymously (the clerk is thus known to the system and associated with the transaction tied to the giftee, since the prefix can be recorded at the time the merchant code is processed.)

A further innovation of the present invention is to allow for modal validation. This refers to a mechanism whereby the merchant may present a special (unique) code to the phone validation system that tells the microgift system that the merchant is now listening to the phone system (or interacting with the smart phone). In this case, the phone system can now safely report not only the gift key, but the quantity of the gift being redeemed. While it is possible to encode gift quantities in the gift key (e.g., using 100 different gift keys associated with one merchant code to encode quantities 1 . . . 100) or let the giftee validate, for example, 32 roses 32 different times, offering a convenient way to securely state quantities can be more efficient. If the customer was allowed to state quantities to the merchant without one of these mechanisms, the merchant could not be sure that the customer was telling the truth. It will be seen that in the present system, secure validation and invalidation (preventing duplicate gift redemptions) is possible as long as the merchant code sheet is protected from the customer's view (so that the customer cannot know in advance what a valid key is).

In another embodiment of the validation process, the giftee may present an account number (such as a phone number) and a PIN to the merchant who can use the Internet to query available gifts for that account. The use of a PIN is essential since well-known account numbers such as phone numbers can easily be used fraudulently to claim gifts not belonging to the claimant.

Merchant Signup

The microgift system provides a mechanism wherein a third party may ‘claim’ a merchant from a list of unclaimed merchant if the third party has not previously claimed this merchant or a sufficient amount of time has expired. The third party is be given a fixed amount of time to persuade the merchant to offer gifts in the microgift system. It may be taken as prima facie proof that the claimant was successful if this happens, even if the merchant was going to sign up anyway. The successful claimant may then be offered compensation, such as one or more free gifts for the merchant they signed up. In addition, having success might entitle the claimant to be allowed to claim additional merchants, or more merchants than a novice claimant might otherwise be entitled to.

The microgift system collects payment from giftors. If a gift is redeemed, the pre-negotiated price of the gift is added to the account tied to the merchant and the convenience and transaction fees are deducted from the amount paid by the giftor. If the giftor is the merchant, it may be the case that there are no transaction fees and the merchant is due no funds for the value of the gift. In this situation, the microgift system arranges to bill the merchant for any commission fees due on the issuance of a microgift. The microgift system also manages viral distribution of gifts should the merchant select this option. In this setting, the merchant and/or the microgift system may designate selected customers to receive free gifts to distribute, wherein each recipient who redeems a gift is entitled to distribute a number of free gifts. The microgift system tracks each account bound to a viral gift to prevent multiple redemptions by the same account.

Other Features of the Microgift System

The microgift system tracks the gift giving and redemption history of every account holder. In addition, users may be asked to specify preferences (e.g., “dog owner”) that can be used to target gifts. A giftor (who may be a manufacturer or retailer) can use this information to better target a gift likely to be appreciated by the giftee. For example, a pet store might wish to target the entire set of microgift accounts who live within a given geographical area with dog treats, as long as those accounts have a preference profile or redemption history indicating a likelihood of the customer having a dog. Another example: someone who redeemed a gift for wine glasses might be offered a gift of wine by a wine manufacturer eager to obtain new trial of their brand. As another example, a giftor may wish to simply give a gift to a giftee at a merchant where they have frequently previously redeemed gifts. Still another example: a gin manufacturer might allow a specific bar to issue some number of gifts of a free gin drink employing the manufacturer's new flavor of gin. This benefits the bar (the customer has to return to receive the gift, which can be date-restricted to start its validity period at some time in the future) as well as the manufacturer (who gets a trial of its new flavor).

By allowing retailers to select followers of their social media, the microgift system provides a mechanism for retailers to encourage loyalty. For example, a store owner who recognizes a follower as a frequent shopper could surprise that shopper with a surprise gift, delivered to that shopper via the microgift system, and validated with the microgift validation mechanisms to ensure fraud-free redemption.

A manufacturer or retailer can use the microgift system to offer an incentive to use their social media. As an example, by being a registered ‘friend’ of the business on social media, the business might randomly give gifts to some set of participants. Hence, being a friend of the business entitles the friend to tangible benefits. A manufacturer would be able to work collaboratively with local merchants—for example, to offer gifts of their product at cooperating local merchants who sell that gift. The microgift system manages the gift offering to avoid duplicate manufacturer gifts being offered at different merchants by ensuring that only one (or a fixed maximum) number of the manufacturer's offerings is redeemable by the giftee. Merchants and manufacturers can advertise the fact that followers of their social media are entitled to receive free gifts as an added incentive to follow that business.

Giftors may elect to remain anonymous with respect to the giftee. In this case, the giftee does not receive any indication of who provided the gift. However, the fact that the giftor gave a gift (without identifying the giftee) may still be ‘posted’ to social media messaging systems to identify the generosity of the giftor.

The microgift system may be configured to automatically deliver gifts on certain days (such as birthdays and anniversaries) or when certain patterns are detected in a user's social history (for example, when a user indicates they are travelling to a specific location).

Co-marketing strategies are easily implemented. For example, a pet store might be authorized to give gifts of a free pet shampoo at a different service provider than the pet store to purchases of pet combs. The microgift system can track such third-party sales efforts so that the pet shampoo provider can compensate the pet store owner appropriately.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A computer system that implements a microgifting service where a specific gift, valid only for a specific amount of time, is provided via the system upon purchase by a giftor to a giftee, where said giftor is notified by the system upon redemption or expiration of said gift, and where the value of the gift is refunded to the giftor should the gift expire.

2. The system in claim 1 where the gift is a specific item at a given merchant

3. The system in claim 1 where the gift is a specific amount redeemable at a given merchant

4. The system in claim 2 where ‘merchant’ refers to a chain of related merchants

5. The system in claim 3 where ‘merchant’ refers to a chain of related merchants.

6. The system of claim 1 where the value of the gift exceeds the price of the gift, and the unused value is refunded to the giftor.

7. The system of claim 1 wherein the gift delivery mechanism consists of a redemption code which is verified by the merchant, and upon redemption of said code, the system generates a credit payable to the merchant for the value of said gift.

8. The system of claim 1 wherein the gift delivery mechanism consists of a credit/debit card code linked to an amount valid for said gift.

9. The system of claim 7 wherein additional information about a gift redemption is supplied with said redemption code.

10. The system of claim 1 wherein the gift delivery mechanism requires the giftee to provide a merchant code provided by the merchant to the service network, said service network providing a confirmatory gift code that must match the gift code linked to the merchant code and in the possession of the merchant.

11. The system of claim 1 wherein different giftors may purchase gifts for the same giftee such that identical gifts are linked to a single gift delivery mechanism.

12. The system of claim 10 where said delivery mechanism is comprised of a credit/debit card comprised of the aggregated value of said identical gifts.

13. The system of claim 1 wherein the giftee may elect to redeem a gift by donating the value of the gift to a designated charity instead of redeeming via the presentation of redemption means to the merchant.

14. The system of claim 1 wherein the giftor is a manufacturer that targets a selected set of giftees to receive a specific gift.

15. The system of claim 14 wherein the giftee must perform a specified act in order to receive said gift.

16. A computer system that implements a gifting service where a list of potential affiliated merchants is maintained and may be claimed by third parties such that the third party receives compensation when this merchant enrolls in the system.

17. The system in claim 16 wherein the number of merchants that may be claimed by an individual third party is limited based upon the prior history of said third party with regards to prior merchant enrollment.
